(19) United States
(12) Patent Application Publication
(10) Pub. No.: US 2024/0346633 A1
(43) Pub. Date: Oct. 17, 2024

(54) INFORMATION PROCESSING APPARATUS, INFORMATION PROCESSING METHOD, AND NON-TRANSITORY COMPUTER READABLE MEDIUM

(71) Applicants: CANON KABUSHIKI KAISHA, Tokyo (JP); CANON MEDICAL SYSTEMS CORPORATION, Tochigi (JP)

(72) Inventors: Takahiro KUROYAMA, Kanagawa (JP); Ryo ISHIKAWA, Kanagawa (JP); Itaru OTOMARU, Kanagawa (JP)

(21) Appl. No.: 18/629,010

(22) Filed: Apr. 8, 2024

(30) Foreign Application Priority Data
Apr. 12, 2023 (JP) 2023-064794

(51) Int. Cl. G06T 7/00

(52) U.S. Cl. CPC G06T 7/00; G06T 2207/20081

(57) ABSTRACT

An information processing apparatus for generating a learning model that performs, by using input image data obtained by imaging an object, estimation relating to the object rendered in the image data, includes at least one processor capable of causing the information processing apparatus to function as a training data acquisition unit configured to acquire, as training data used for generating the learning model, learning image data obtained by imaging the object and ground truth data indicating information about the object in the learning image data, a goodness-of-fit acquisition unit configured to acquire goodness of fit relating to the ground truth data, and a learning unit configured to perform training on the learning model based on the training data and the goodness of fit.

### BACKGROUND OF THE INVENTION

### Field of the Invention

The present invention relates to an information processing apparatus, an information processing method, and a non-transitory computer readable medium.

### Description of the Related Art

In recent years, classifiers based on deep learning have been attracting attention in the field of image processing. In a method called supervised learning, an estimator (also called an inference device, a learning model, an inference model, etc.) is trained by using a training data set formed by gathering training data (also called training data pairs) each including learning image data and ground truth data corresponding to the learning image data. Various techniques for improving the estimation accuracy of the estimator have been proposed.

One example of such techniques is a data cleansing process for removing training data including ground truth data, which is likely to have low reliability, from the training data set. In addition, there has been proposed a technique in which, when there is an imbalance among classes in the number of ground truth data included in a training data set or when the coordinates of ground truth data are inaccurate or inconsistent, such imbalance or inconsistency is resolved by applying a preset weight to a loss function.

For example, Japanese Patent Application Publication No. 2019-106140 discloses a technique for generating an estimator by using an activation function obtained by applying different weights to different labels in training information, which includes learning images and correct output information corresponding to labels representing objects of interest. Further, Japanese Patent Application Publication No. 2019-28532 discloses a technique for performing image alignment on two pieces of image data by using, as weights, dispersion based on respective locations of feature points on the image data.

However, according to the above-described conventional techniques, although different weights are applied depending on the feature points at the time of calculation using the activation function, a common weight is applied to the individual training data included in the training data set. Therefore, if some training data included in the training data set has low reliability, the estimation accuracy of the estimator may decrease due to the impact of the training data with low reliability.

In view of the above problem, it is an object of the present disclosure to provide a technique for improving the accuracy of estimation relative to an object in an image.

### SUMMARY OF THE INVENTION

According to some embodiments, an information processing apparatus for generating a learning model that performs, by using input image data obtained by imaging an object, estimation relating to the object rendered in the image data, includes at least one processor capable of causing the information processing apparatus to function as: a training data acquisition unit configured to acquire, as training data used for generating the learning model, learning image data obtained by imaging the object and ground truth data indicating information about the object in the learning image data, a goodness-of-fit acquisition unit configured to acquire goodness of fit relating to the ground truth data, and a learning unit configured to perform training on the learning model based on the training data and the goodness of fit. In addition, according to some embodiments, an information processing apparatus, includes at least one processor capable of causing the information processing apparatus to function as: a data acquisition unit configured to acquire input image data obtained by imaging an object, a learning model acquisition unit configured to acquire a learning model generated by learning based on learning image data obtained by imaging the object, ground truth data indicating information about the object in the learning image data, and goodness of fit relating to the ground truth data, and an estimation unit configured to perform an estimation process relating to the object rendered in the input image data by using the input image data and the learning model.

Further, according to some embodiments, an information processing method for generating a learning model that performs, by using input image data obtained by imaging an object, estimation relating to the object rendered in the image data, includes a training data acquisition step of acquiring, as training data used for generating the learning model, learning image data obtained by imaging the object and ground truth data indicating information about the object in the learning image data, a goodness-of-fit acquisition step of acquiring goodness of fit relating to the ground truth data, and a learning step of performing training on the learning model, based on the training data and the goodness of fit. In addition, according to some embodiments, an information processing method includes a data acquisition step of acquiring input image data obtained by imaging an object, a learning model acquisition step that acquires a learning model generated by learning, based on learning image data obtained by imaging the object, ground truth data indicating information about the object in the learning image data, and goodness of fit relating to the ground truth data, and an estimation step of performing an estimation process relating to the object rendered in the input image data by using the input image data and the learning model.

Further features of the present invention will become apparent from the following description of exemplary embodiments with reference to the attached drawings.

### BRIEF DESCRIPTION OF THE DRAWINGS

FIG. 1 is diagram schematically illustrating a configuration of an information processing apparatus according to Embodiments 1 to 3;

FIG. 2 is a flowchart illustrating a process performed by the information processing apparatus according to Embodiments 1 and 2;

FIG. 3 is a sub-flowchart illustrating a process performed by the information processing apparatus according to Embodiments 1 and 2;

FIGS. 4A and 4B are diagrams illustrating feature points and goodness of fit of learning image data according to an embodiment;

FIG. 5 is a flowchart illustrating a process performed by the information processing apparatus according to Embodiment 3; and

FIG. 6 is a sub-flowchart illustrating a process performed by the information processing apparatus according to Embodiment 3.

### DESCRIPTION OF THE EMBODIMENTS

Hereinafter, embodiments of a technique according to the present disclosure will be described in detail based on the drawings. However, the constituent elements described in the following embodiments are merely examples, and the technical scope of the technique of the present disclosure is determined by the scope of the claims and is not limited to the following individual embodiments.

### Embodiment 1

Hereinafter, an information processing apparatus according to Embodiment 1 will be described. In the present embodiment, an information processing apparatus using a convolutional neural network (CNN), which is an estimator based on deep learning, as a type of machine learning will be described as an example.

Learning image data used by the information processing apparatus according to the present embodiment is image data obtained by imaging an object of interest, which is an object present in a real space, by an image capturing apparatus. In the learning image data, the object of interest is rendered. Ground truth data corresponds to the learning image data and defines a correct output of an inference result outputted by the estimator. For example, when the contour of an object of interest in the image data is estimated by the estimator, the contour in the ground truth data is defined as sets of coordinate values representing the position of the point cloud forming the contour line of the object of interest in the learning image data. The ground truth data of such a contour is typically created by a person such as a doctor or a technician creating coordinate data (hereinafter, referred to as annotation). Upon creating the ground truth data, there is a case where the reliability of the ground truth data is reduced due to the poor image quality of the learning image data, the ability of the creator of the ground truth data, etc.

Here, “the data with low reliability” refers to data based on learning image data with low image quality or inaccurate and inconsistent ground truth data. If training is performed by using such ground truth data considered to have low reliability, effective training cannot be performed. This could cause a decrease in accuracy of the estimation performed by the estimator obtained as a result of the training.

In contrast, even when the training data set includes ground truth data with low reliability, the information processing apparatus according to the present embodiment can reduce the impact of the ground truth data with low reliability on the learning and prevent a decrease in accuracy of the estimation performed by the estimator, as will be described below.

The information processing apparatus according to the present embodiment is an apparatus for estimating the contour of an object from an input image, which is image data in which the object is rendered, and has a function of generating an estimator (learning model) and a function of performing estimation on an unknown image.

Specifically, first, in a learning process, the information processing apparatus generates an estimator for estimating coordinate values of a point-cloud position representing the contour of an object included in an image by using a training data set including image data. Next, in an estimation process, the information processing apparatus estimates coordinate values of a point cloud representing the contour of an object included in an unknown input image (processing target image) by using the generated estimator. In the present embodiment, a case where a three-dimensional cardiac ultrasound image captured in a cardiac ultrasound examination is an input image will be described as an example. In this example, a right ventricle in the input image is an object to be estimated, and coordinate values of the point cloud representing the endocardial contour of the right ventricle will be estimated.

In the learning process according to the present embodiment, a relationship between the input and output of the estimator corresponds to the training data set, and the information processing apparatus configures the estimator such that the input is the three-dimensional cardiac ultrasound image and the output is the coordinate values of the point-cloud position representing the endocardial contour of the right ventricle. The information processing apparatus then calculates a difference between the coordinate values, which are the output of the estimator, and coordinate values indicated by the ground truth data as a loss value and optimizes the estimator (learning model) such that the calculated loss value is minimized. Next, in the estimation process according to the present embodiment, the information processing apparatus estimates the coordinate values of the point cloud representing the endocardial contour of the right ventricle, which is an estimation target, by using the generated estimator and an unknown three-dimensional cardiac ultrasound image as the input.

The information processing apparatus according to the present embodiment acquires, as the input image (processing target image), three-dimensional cardiac ultrasound image data captured by a user such as a doctor or a technician using an ultrasound probe. Next, the information processing apparatus acquires the learning model generated above and performs the estimation process on the input image data.

The acquisition of the estimator (learning model) according to the present embodiment is performed as follows. First, the information processing apparatus acquires a training data set to be learned. In the present embodiment, a set (pair) of a three-dimensional cardiac ultrasound image and ground truth data representing the shape of the endocardial contour of a right ventricle rendered in this three-dimensional cardiac ultrasound image is defined as one piece of training data (also referred to as “training data pair”). Further, a collection of a plurality of training data pairs is defined as a training data set.

More specifically, the ground truth data according to the present embodiment is data of positional coordinates of a point cloud discretely formed along the endocardial contour of the right ventricle. In the present embodiment, the positional coordinates of each point included in the point cloud along the endocardial contour in the ground truth data are referred to as “correct endocardial contour point”. Each point of the endocardial contour point cloud is an example of a feature point, and the right ventricular region, the endocardium, the endocardial contour, and the feature points are examples of spatial information of the object. Next, the information processing apparatus calculates goodness of fit that represents reliability for each point of the endocardial contour point cloud in the ground truth data. Specifically, the goodness of fit relating to the ground truth data is an indicator (level of reliability) representing how reliable the correct output (endocardial contour point) indicated by the ground truth data in each training data pair can be as the data indicating the actual region of the object. Next, the information processing apparatus calculates a loss value relating to the positional coordinates of each correct endocardial contour point. The loss value is weighted by an error value based on the goodness of fit of the corresponding correct endocardial contour point. Next, the information processing apparatus optimizes the estimator such that the calculated loss value is minimized. Note that the three-dimensional cardiac ultrasound image and the positional coordinates of the point cloud including the correct endocardial contour points of the right ventricle, which have been described above in the acquisition of the estimator (learning model), are examples of the learning image data and the ground truth data. The estimator according to the present embodiment is configured by a CNN, and as a specific example thereof, a known network such as VGG16 or Dense Net can be used.

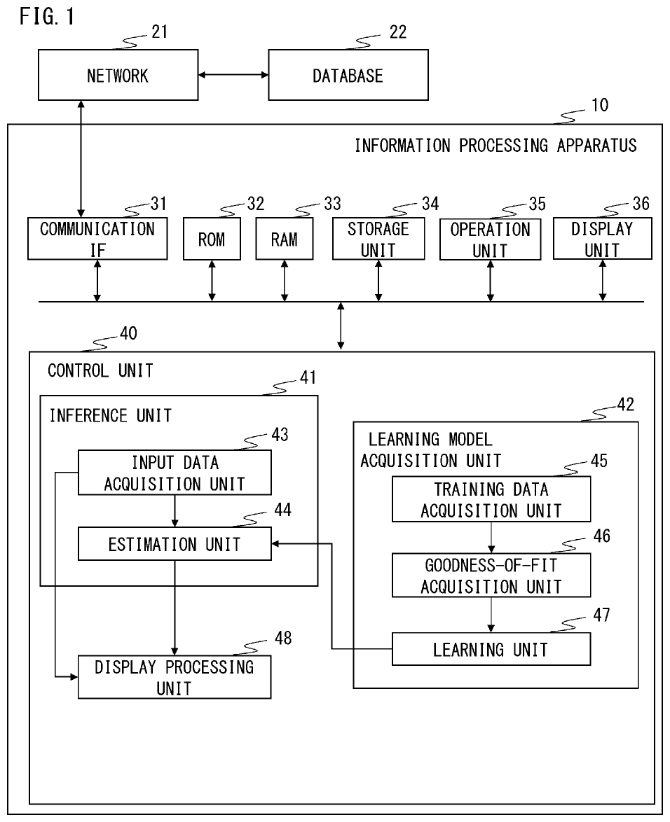

Hereinafter, a configuration and processing of the information processing apparatus according to the present embodiment will be described with reference to FIG. 1. FIG. 1 is a block diagram illustrating an example of a configuration of an information processing system 1 (also referred to as a medical information processing system) including an information processing apparatus 10 according to the present embodiment. The information processing system 1 includes the information processing apparatus 10 and a database 22. The information processing apparatus 10 is communicably connected to the database 22 via a network 21. The network 21 includes, for example, a local area network (LAN) or a wide area network (WAN).

The database 22 holds and manages images and information used in the processing described below. The information managed by the database 22 includes an image (input image, processing target image) fed to the network and a training data set for generating an estimator (learning model). In addition, information (a structure and parameters of a model, which will be described in detail below) about the estimator generated by a learning model acquisition unit 42 using the training data set may be included. The information about the estimator may be stored in an internal storage (a read only memory (ROM) 32 or a storage unit 34) of the information processing apparatus 10 instead of the database 22. The information processing apparatus 10 can acquire data held in the database 22 via the network 21.

The information processing apparatus 10 includes a communication interface (IF) (communication unit) 31, the ROM 32, a random access memory (RAM) 33, the storage unit 34, an operation unit 35, a display unit 36, and a control unit 40.

The communication IF (communication unit) 31 includes a LAN card or the like and realizes communication between an external device (for example, the database 22 or the like) and the information processing apparatus 10. The ROM 32 is a non-volatile memory or the like and stores various kinds of programs and data. The RAM 33 is a volatile memory or the like and is used as a work memory for temporarily storing a program and data being executed. The storage unit 34 is a hard disk drive (HDD) or the like and stores various kinds of programs and data. The operation unit 35 is a keyboard, a mouse, a touch panel, or the like and enters instructions from a user (for example, a doctor or a technician) into each unit of the information processing apparatus 10.

The display unit 36 is a display or the like and displays various kinds of information to the user. The control unit 40 is a central processing unit (CPU) or a dedicated or general-purpose processor. The control unit 40 may be a graphic processing unit (GPU), a field-programmable gate array (FPGA), or the like. Alternatively, the control unit 40 may be an application specific integrated circuit (ASIC). The control unit 40 includes an inference unit 41 and the learning model acquisition unit 42, which will be described below. The inference unit 41 includes an input data acquisition unit 43 and an estimation unit 44, and the learning model acquisition unit 42 includes a training data acquisition unit 45, a goodness-of-fit acquisition unit 46, and a learning unit 47.

The input data acquisition unit 43 acquires input image (processing target image) data to be processed from the database 22 or the storage unit 34. The input image data is, for example, image data of an object of a subject (patient) acquired by an ultrasound diagnostic apparatus (not illustrated). In the present embodiment, three-dimensional cardiac ultrasound image data obtained by imaging the heart (object) from the body surface of the subject is used as an example. The input data acquisition unit 43 may directly acquire the input image data from the ultrasound diagnostic apparatus. In this case, the information processing apparatus 10 may be mounted on the ultrasound diagnostic apparatus as a part of the function of the ultrasound diagnostic apparatus. While the input image data is a three-dimensional medical image in the present embodiment, the input image data may be a two-dimensional image or an image other than a medical image.

The estimation unit 44 estimates the coordinate values of the point cloud along the contour of the object, which is the estimation target, from the input image data acquired by the input data acquisition unit 43 by using the learning model acquired by the learning model acquisition unit 42. The estimation unit 44 according to the present embodiment uses three-dimensional cardiac ultrasound image data as the input to the learning model and obtains the coordinate values of the point-cloud position representing the endocardial contour of the right ventricular region as a processing result.

The training data acquiring unit 45 acquires a training data set from the database 22 or the storage unit 34. The training data set includes a plurality of training data pairs each of which includes learning image data and ground truth data corresponding to the learning image data. The learning image data is image data of an object expressed in the same format as the input image data. In the present embodiment, three-dimensional cardiac ultrasound image data obtained by imaging the heart is used as an example. The ground truth data is data indicating the estimation target expressed in the same format as the processing result obtained by the estimation unit 44. In the present embodiment, three-dimensional coordinate values indicating the point-cloud position representing the endocardial contour of the right ventricular region included in the three-dimensional cardiac ultrasound image data are used as an example. While the coordinate values of the point-cloud position representing the endocardial contour are the estimation target in the present embodiment, the present embodiment is applicable to a case where the coordinate values of the position of a landmark are the estimation target instead of the contour point-cloud.

The goodness-of-fit acquisition unit 46 calculates the goodness of fit of the coordinate values of the ground truth data of each training data pair included in the training data set. The goodness-of-fit acquisition unit 46 according to the present embodiment calculates and acquires the goodness of fit based on the pixel values of the point-cloud position representing the endocardial contour of the right ventricular region included in the three-dimensional cardiac ultrasound image data.

The learning unit 47 calculates, for each training data pair included in the training data set, a difference (error value) between the coordinate values (estimated data, estimated coordinates) of the point-cloud position representing the endocardial contour in the learning image data, which have been estimated by the current estimator, and the coordinate values (correct coordinates) of the point-cloud position representing the endocardial contour in the ground truth data. The learning unit 47 calculates the error value based on an error evaluation function. Next, the learning unit 47 calculates a loss value by multiplying the calculated error value by the goodness of fit acquired by the goodness-of-fit acquisition unit 46 as a weight. Next, the learning unit 47 updates the estimator such that the calculated loss value is minimized. The learning unit 47 repeats the calculation of the loss value and the update of the estimator until the update of the estimator has been performed for a preset number of times.

The learning unit 47 according to the present embodiment calculates an error value between the coordinate values of the estimated point-cloud position representing the endocardial contour of the right ventricular region estimated from learning parameters and the ground truth data by using an error evaluation function. The loss value is calculated by multiplying the calculated error value by the goodness of fit calculated by the goodness-of-fit acquisition unit 46.

In the present embodiment, the calculation of the loss value and the update of the estimator are repeated until the estimator has been updated for a preset number of times. However, the repetition process may be terminated when the parameter update interval included in the estimator is smaller than a specified value. The display processing unit 48 outputs the input image data acquired by the input data acquisition unit 43 and the coordinates estimated by the estimation unit 44 to the display unit 36.

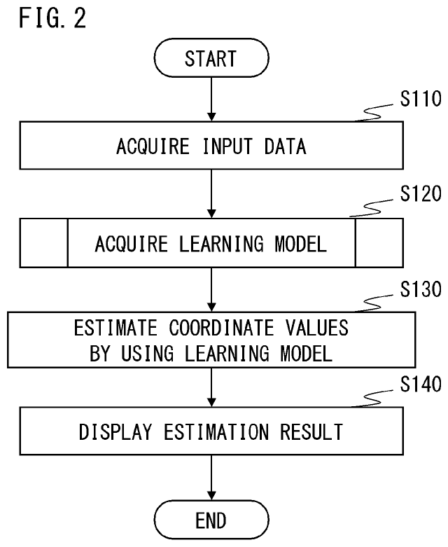

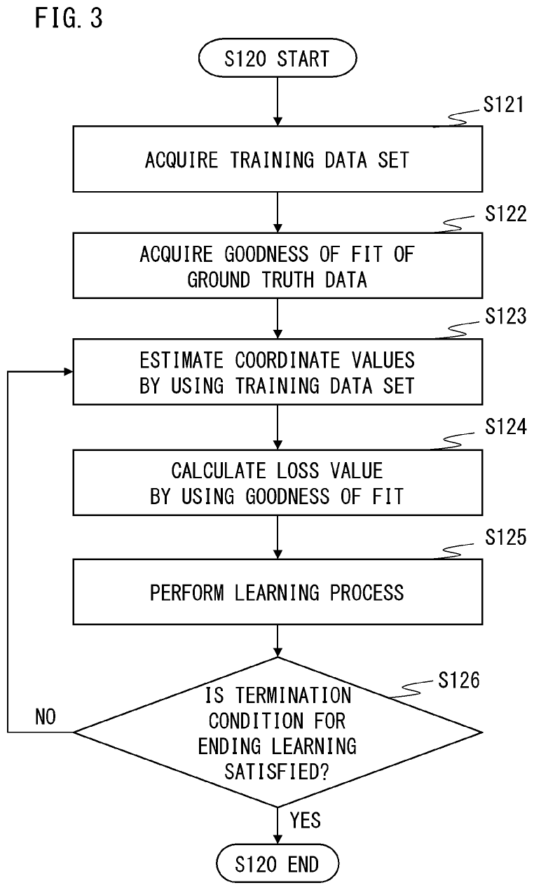

Hereinafter, an example of a process performed by the information processing apparatus 10 in FIG. 1 will be described in detail with reference to flowcharts in FIGS. 2 and 3.

(Step S110: Acquire Input Data) In step S110, the input-data acquiring unit 43 acquires input image data specified by the user using the operation unit 35 from the database 22 and stores the acquired input image data in the storage unit 34. Alternatively, the input data acquisition unit 43 may acquire the input image data by using a method other than the above method. For example, the input data acquisition unit 43 may sequentially acquire image data captured by the image capturing device at short intervals as input image data. The display processing unit 48 may display the acquired input image data on the display unit 36. The processing in this step may be performed after the processing in step S120.

(Step S120: Acquire Learning Model) In step S120, the learning model acquisition unit 42 acquires an estimator (learning model). In the present embodiment, a CNN (hereinafter, referred to as a contour estimation CNN) is used as the estimator. Next, the learning model acquisition unit 42 stores the contour estimation CNN obtained by the above processing in the database 22 or the storage unit 34. The processing in step S120 will be described in detail below with reference to the sub-flowchart in FIG. 3.

(Step S121: Acquire Training Data Set) In step S121, the training data acquisition unit 45 acquires the training data set specified by the user using the operation unit 35 from the database 22 and stores the acquired training data set in the storage unit 34. Alternatively, the training data acquisition unit 45 may acquire the training data set by using a method other than the above method. For example, the training data acquisition unit 45 may sequentially acquire images captured by the image capturing device at short intervals, and the user may create ground truth data for each of the acquired images.

In the present embodiment, the estimator estimates the coordinate values of the point-cloud position representing the endocardial contour of the right ventricular region. However, the estimator may learn the coordinate values of the point-cloud position representing the contour of another ventricle or atrium. In addition, the estimator is not limited to estimating the coordinate values of the point-cloud position representing the contour and may learn and estimate the coordinate values of a landmark position of the valve and the like included in the heart region.

(Step S122: Acquire Goodness of Fit of Ground Truth Data) In step S122, the goodness-of-fit acquisition unit 46 calculates the goodness of fit for each training data pair included in the training data set acquired in step S121. Specifically, the goodness-of-fit acquisition unit 46 calculates and acquires the goodness of fit of the ground truth data relating to each contour point based on the pixel value at the position of each contour point corresponding to the ground truth data in the learning image data.

In the present embodiment, the goodness-of-fit acquisition unit 46 calculates the goodness of fit of the ground truth data relating to the contour point for each training data pair. The right ventricular region is a chamber region that is separated from other adjacent regions by a wall. Typically, in an ultrasound image, the wall is rendered with a high pixel value, and the chamber is rendered with a low pixel value. That is, the point cloud representing the endocardial contour of the right ventricle is estimated by extracting a boundary between the region with a high pixel value and the region with a low pixel value. Therefore, based on the pixel values of the three-dimensional cardiac ultrasound image at the contour-point position indicated by the corresponding ground truth data, the goodness of fit is calculated such that the goodness of fit of the ground truth data having a higher pixel value becomes higher and the goodness of fit of the ground truth data having a lower pixel value becomes lower. More specifically, when the pixel value of the three-dimensional cardiac ultrasound image is represented by an unsigned 8-bit integer, the goodness of fit of the ground truth data at the contour point having the minimum pixel value (“0”) is represented by 0.0, and the goodness of fit of the ground truth data at the contour point having the maximum pixel value (“255”) is represented by 1.0. The goodness-of-fit acquisition unit 46 calculates the goodness of fit (a value between 0.0 and 1.0, inclusive) for every one of the training data pairs included in the training data set.

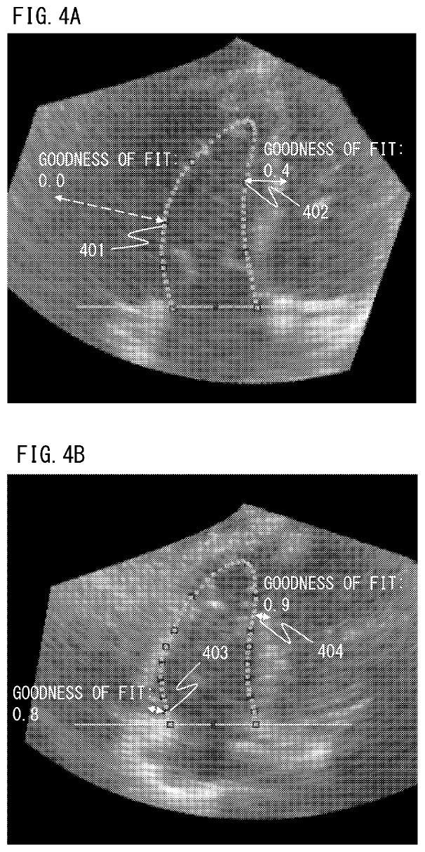

FIGS. 4A and 4B illustrate examples of the goodness of fit in the learning image data of the right ventricular region. In the image illustrated in FIG. 4A, a contour point 401 included in the point cloud representing the endocardial contour of the right ventricle has a goodness of fit of 0.0 because the periphery of the contour point 401 in the ultrasound image is unclear, and the contour point 401 has the minimum pixel value. Another contour point 402 included in the point cloud representing the endocardial contour of the right ventricle has a goodness of fit of 0.4 because the contour point 402 has a moderate pixel value (for example, 120). In the image illustrated in FIG. 4B, a contour point 403 included in the point cloud representing the endocardial contour of the right ventricle has a goodness of fit of 0.8 because the periphery of the contour point 403 in the ultrasound image is somewhat clear, and the contour point 403 has a pixel value close to its maximum value (for example, 200). Another contour point 404 included in the point cloud representing the endocardial contour of the right ventricle has a goodness of fit of 0.9 because the periphery of the contour point 404 in the ultrasound image is clear, and the contour point 404 has even higher pixel value (for example, 240) than that of the contour point 403. In FIGS. 4A and 4B, the goodness of fit is calculated for the other contour points in the same manner, and the contour point and its corresponding goodness of fit are paired for each contour point. As indicated by the arrows in FIGS. 4A and 4B, the smaller the distance between the contour point and the endocardial contour is, the higher the goodness of fit is. Further, as illustrated in FIGS. 4A and 4B, different goodness of fit may be paired with the contour point in each learning image data.

In the above-described embodiment, as an example, based on the pixel value at the position of the contour point indicated by the ground truth data, the goodness-of-fit acquisition unit 46 calculates the goodness of fit of the ground truth data corresponding to this contour point. However, the calculation of the goodness of fit is not limited to this example. For example, the goodness-of-fit acquisition unit 46 may calculate the goodness of fit based on the pixel values of the periphery of the position of the contour point indicated by the ground truth data. As another example, the goodness-of-fit acquisition unit 46 may calculate an edge strength at the position corresponding to the coordinate values in the ground truth data based on the pixel values of the periphery of this position and calculate the goodness of fit based on the calculated edge strength.

In this case, the goodness-of-fit acquisition unit 46 can calculate the edge strength based on a spatial gradient, such as a luminance gradient, indicated by the pixel values. Specifically, the goodness-of-fit acquisition unit 46 can calculate the edge strength based on the spatial gradient of the pixel values in the direction orthogonal to the endocardial contour line (line connecting between adjacent endocardial contour points) calculated from the point cloud representing the endocardial contour. Alternatively, a calculation method other than this calculation method may be used. For example, the goodness-of-fit acquisition unit 46 calculates an edge strength at a plurality of positions in the direction orthogonal to the endocardial contour line. As the position at which any of the calculated edge strengths is equal to or more than a predetermined edge strength serving as a threshold is located closer to the endocardial contour line, the goodness-of-fit acquisition unit 46 calculates the goodness of fit to be higher, and as this position is located farther from the endocardial contour line, the goodness-of-fit acquisition unit 46 calculates the goodness of fit to be lower. Further, when the position at which the calculated edge strength is equal to or more than the threshold is located away from the endocardial contour line by a distance exceeding a certain distance, the goodness-of-fit acquisition unit 46 may set the goodness of fit to 0.

The method for calculating the goodness of fit by the goodness-of-fit acquisition unit 46 may be a method for calculating the goodness of fit based on the mutual positional relationship between the correct endocardial contour points, such as the curvature of the endocardial contour line calculated based on the point-cloud position representing the endocardial contour. Specifically, the goodness-of-fit acquisition unit 46 calculates the curvature based on the positional relationship between the endocardial contour point for which the goodness of fit is to be calculated and each of the adjacent endocardial contour points on the endocardial contour line. In this way, the goodness-of-fit acquisition unit 46 calculates the goodness of fit of each feature point in the ground truth data included in the training data based on the positional relationship between one target feature point and feature points other than the target feature point. This positional relationship is regarded as the curvature of the contour line of the object based on each feature point.

The method for calculating the goodness of fit does not need to be the same for all correct endocardial contour points, and different calculation methods may be used for different points of the point cloud forming the endocardial contour line. Specifically, different calculation methods may be used for points corresponding to the position of the tricuspid annulus and the other points of the point cloud representing the endocardial contour of the right ventricle. For example, the goodness-of-fit acquisition unit 46 may calculate the goodness of fit of the points located at the tricuspid annulus based on the pixel values of the image data at the corresponding position and may calculate the goodness of fit of the other points based on the mutual positional relationship between the endocardial contour points.

(Step S123: Estimate Coordinate Values by Using Training Data Set) In step S123, the learning unit 47 performs estimation on the learning image data acquired in step S121 by using an estimator (learning model) generated by using parameters of the current (presently learning) contour estimation CNN. The learning unit 47 then calculates coordinate values (estimated data, estimated coordinates) of the point-cloud position representing the endocardial contour of the right ventricular region as the estimation result. Typically, the learning parameters of the contour estimation CNN are weights and biases of kernels of multiple convolution layers, offsets and scale coefficients of layers used for learning, and the like. Note that a known method using a CNN can be adopted as the estimation method based on the image data and the learning parameters in this step.

(Step S124: Calculate Loss Value by Using Goodness of Fit) In step S124, the learning unit 47 calculates a loss value relating to each training data pair. Specifically, the learning unit 47 performs error evaluation on each contour point by using a preset error evaluation function and calculates an error value from the estimated data calculated in step S123 and the ground truth data acquired in step S121. Next, the learning unit 47 multiplies the error value of the estimated data for each contour point by the goodness of fit of the ground truth data of the corresponding contour point calculated in step S122 and then adds up all the calculation results to obtain a loss value. Alternatively, the learning unit 47 may divide the endocardial contour into a plurality of contour segments, multiply the error value of the estimated data for each contour point by the goodness of fit of the ground truth data of the corresponding contour point, and then add up the calculation results to obtain a loss value for each divided contour segment. The learning unit 47 can calculate the loss value for each of the plurality of divided contour segments.

Specifically, the learning unit 47 calculates an error value for each contour point by using a known method, for example, a preset error evaluation function such as a mean squared error (MSE). Further, the learning unit 47 calculates a loss value for each contour point by multiplying the calculated error value of each contour point by the goodness of fit of the ground truth data of the corresponding contour point. Further, the learning unit 47 calculates a loss value for each training data pair by adding up the loss values of the respective contour points.

The learning unit 47 performs the above-described process for calculating the loss value relating to the training data pair on all the training data pairs and obtains a mean value of the loss values of all the training data pairs so as to calculate a loss value of the training data set. A function for performing this series of loss value calculation processes is referred to as a loss function. In the present embodiment, the learning unit 47 calculates the error value of the estimated data for each contour point by using the MSE as the error evaluation function. Next, the learning unit 47 multiplies the calculated error value of the estimated data for each contour point by the goodness of fit of the ground truth data of the corresponding contour point. The learning unit 47 then calculates a loss value by obtaining a mean value of the values obtained by the multiplication.

The method for calculating the loss value by the learning unit 47 in this step is not limited to the methods described above, and a method in which a three-dimensional distance between the point of the estimated data (estimated coordinates) and the point of the ground truth data (correct coordinates) is used as the error value for each estimated point may be adopted. Alternatively, as the error evaluation function in this step, an error evaluation function that calculates an error value by adding an error value of estimated data calculated by using the MSE for each contour point and an error value calculated from a three-dimensional distance may be used.
(Step S125: Perform Learning Process) In step S125, the learning unit 47 updates the parameters of the contour estimation CNN serving as the estimator to reduce the loss value calculated in step S124 by using a known method such as backpropagation. The parameters of the contour estimation CNN are updated by using an optimization method. Alternatively, a known method such as a stochastic gradient descent (SGD) method or an Adam method can be used as the optimization method. Hyperparameters, such as a learning rate and a batch size, to be set when these methods are used may be set as appropriate by a known method.
(Step S126: Termination Determination of Learning Process) In step S126, the learning unit 47 determines whether to end the learning process. If the learning unit 47 determines to end the learning process, the processing in step S120 is ended, and if not, the processing returns to step S123. In the termination determination of the learning process, the learning unit 47 determines whether a preset termination condition has been satisfied. Examples of the termination condition for ending the learning include a condition based on whether the number of elapsed epochs from the start of the learning (the cumulative total of repetitions that have been performed) or the loss value satisfies a predetermined condition. However, the termination condition is not limited to this example. For example, the learning unit 47 may prepare a validation data set separately from the training data set, and when the estimation accuracy of the validation data set reaches a predetermined condition, the learning process may be ended. The termination condition for ending the learning may be a combination of a plurality of termination conditions. The termination condition of the learning in the present embodiment is whether the number of elapsed epochs from the start of the learning has reached an upper limit (the maximum number of epochs). Thus, the processing from step S123 to step S126 is repeatedly performed for the number of times corresponding to the maximum number of epochs.

As described above, the processing in step S120, in which the learning model acquisition unit 42 acquires the learning model, is performed. That is, the learning model acquisition unit 42 performs training on the contour estimation CNN, generates an estimator (learning model) configured by the contour estimation CNN, and stores the generated estimator in the database 22 or the storage unit 34.
(Step S130: Estimate Coordinate Values by Using Learning Model) In step S130, the estimation unit 44 acquires the estimator (learning model) trained in step S120 from the storage unit 34. The estimation unit 44 then feeds the three-dimensional cardiac ultrasound image data acquired in step S110 to the estimator and estimates the coordinate values of the point-cloud position representing the endocardial contour of the right ventricular region rendered in the three-dimensional cardiac ultrasound image data.
(Step S140: Display Estimation Result) In step S140, the display processing unit 48 outputs the input image data and the coordinate positions based on the result estimated in step S130. For example, the display processing unit 48 may store the data to be outputted in the database 22 or the storage unit 34 or may display the data to be outputted on the display unit 36. In the present embodiment, the display processing unit 48 displays the three-dimensional cardiac ultrasound image of the input image data on the display unit 36 and superimposes, on this image, the points corresponding to the coordinate values of the point-cloud position representing the endocardial contour of the right ventricle estimated in step S130.

The information processing apparatus 10 according to Embodiment 1 thus executes the processes by performing the processing described above. As a result, an estimator is generated by the learning process using the training data set including the three-dimensional cardiac ultrasound image data and the coordinate values of the point-cloud position representing the correct endocardial contour points of the right ventricular region. In the present embodiment, the goodness of fit of each ground truth data is used in the process of generating the estimator. As a result, even when ground truth data with low reliability is included in the training data set, an impact of the ground truth data with low reliability on the learning can be reduced, as an advantageous effect of the present embodiment. Further, since this effect can be obtained without excluding the training data with low reliability from the training data set, the amount of training data used for the learning is not reduced, that is, a decrease in variation of data used for the learning can be prevented. In this way, the information processing apparatus 10 according to the present embodiment can prevent a decrease in accuracy of the estimator.

### Modification 1-1

Hereinafter, a plurality of modifications (Modifications 1-1 to 1-6) of Embodiment 1 will be described. In the following description of the modifications, the same reference numerals are given to the same components as those of Embodiment 1, and the detailed description thereof will be omitted.

First, Modification 1-1 will be described. The information processing apparatus 10 according to Embodiment 1 performs the learning process in step S120 by using the training data set and performs the estimation process in step S130 by using the estimator obtained as a result of the learning process. On the other hand, the information processing apparatus 10 according to the present modification acquires, for example, as the processing in step S120, an estimator generated by performing a learning process in advance from the database 22, the storage unit 34, or the like, instead of performing the learning process using the training data set. The estimator stored in the database 22 or the storage unit 34 can be generated by the same processing as that in step S120 described in Embodiment 1, for example. That is, the estimator generated by the learning process using the training data set is stored in the database 22 or the storage unit 34 in advance, and the information processing apparatus 10 acquires the estimator and performs the processing in step S130 and subsequent steps.

Thus, the processing in step S120 described in Embodiment 1 does not need to be performed by the same information processing apparatus as the information processing apparatus 10 that performs steps S110, S130, and S140. That is, the information processing apparatus 10 may be configured to perform only the processing in the learning process of the above-described estimator or may be configured to perform only the processing in the estimation process using the above-described estimator. In the former case, the information processing apparatus 10 may be configured to include each unit that performs only the processing in step S120 without including the functions of the inference unit 41. In the latter case, the information processing apparatus 10 may be configured without including the functions of the training data acquisition unit 45, the goodness-of-fit acquisition unit 46, and the learning unit 47, and instead, may be configured to include a function of acquiring the estimator stored in the database 22 or the storage 34 as the learning model acquisition unit 42.

In the present modification, the processing in step S120 does not necessarily need to be performed after step S110 or before step S130. The processing in step S140 may be omitted, and the information processing apparatus 10 may be configured to store the information about the estimated date in the database 22 or the storage unit 34. The information processing apparatus 10 may be configured to derive diagnosis support information about the object based on the estimated data and store the diagnosis support information in the database 22 or the storage unit 34 without displaying or storing the estimated data. For example, the information processing apparatus 10 may derive diagnosis support information such as measurement of the shape (e.g. volume) or the function (e.g. ejection fraction) of the object and determination of the state (e.g. deviation from the normal state of a cardiac function) of the object.

### Modification 1-2

Next, Modification 1-2 will be described. The information processing apparatus 10 according to Embodiment 1 estimates the coordinate values of the point-cloud position representing the endocardial contour of the right ventricular region by using the three-dimensional cardiac ultrasound image data captured in the cardiac ultrasound examination. However, as will be described below, the information processing apparatus 10 can perform the estimation process by using information other than the medical image data, that is, information other than the training data relating to the object.

In the present modification, as an example of image data other than medical image data, image data of a human face is used. In this example, the region of a human face is the object. Specifically, the information processing apparatus 10 estimates the position of landmarks (a point cloud representing the contour of a face, for) of a human face from image data of the human face. In this case, for example, the goodness of fit is calculated based on determination of whether the contour of the human face is partially unclear or inaccurate because the face region is partially blocked by a hand, body, mask, or the like in the image of the learning image data included in the training data set. More specifically, when the contour of the face is blocked in the learning image data included in the training data set, the goodness of fit of the ground truth data corresponding to the learning image data is calculated to be lower. When the contour of the face is not blocked in the learning image data, the goodness of fit of the ground truth data corresponding to the learning image data is calculated to be higher.

Next, as in Embodiment 1, the information processing apparatus 10 calculates a loss value based on the calculated goodness of fit and generates an estimator such that the loss value is minimized. Thus, the information processing apparatus 10 according to the present modification can generate a learning model based on the level of reliability of the training data set depending on whether or not a missing portion of the contour of the face exists. As a result, the information processing apparatus 10 can prevent a decrease in accuracy of the estimation on the face landmarks by using the generated estimator.

### Modification 1-3

Next, Modification 1-3 will be described. In the present modification, as will be described below, the information processing apparatus 10 can perform the estimation process by using image data obtained by imaging a region other than the heart.

In the present modification, as an example of the image data obtained by imaging a region other than the heart, image data indicating the endocardial contours of the right ventricular region and the left ventricular region in the three-dimensional cardiac ultrasound image data is used. In this case, the three-dimensional cardiac ultrasound image data obtained by imaging the cardiac region is used as the learning image data, and a training data set using coordinate values of the point-cloud positions representing the endocardial contours of the right ventricular region and the left ventricular region is used as the ground truth data. In the present modification, for example, depending on the imaging range and the imaging angle at the time of the cardiac ultrasound examination, while the right ventricular region may appear clearly, the left ventricular region may appear not clearly, or a part of the region may be located outside the range of the image. In that case, the information processing apparatus 10 calculates the goodness of fit such that the goodness of fit for the right ventricular region, which appears clearly, is higher and the goodness of fit for the left ventricular region, which appears not clearly, is lower. Next, the information processing apparatus 10 calculates a loss value based on the calculated goodness of fit and generates an estimator such that the loss value is minimized. In this way, the information processing apparatus 10 according to the present modification can generate a learning model based on the reliability of the training data set including image data obtained by imaging a region other than the heart.

### Modification 1-4

Next, Modification 1-4 will be described. In the present modification, as will be described below, the information processing apparatus 10 can perform the estimation process by using image data obtained by imaging an organ other than the heart or image data obtained by other modalities.

In the present modification, as an example of the image data obtained by other modalities, computed tomography (CT) image data obtained by imaging an organ such as a lung is used. For example, the information processing apparatus 10 generates an estimator for estimating the coordinate values of the point-cloud position representing the contour of the organ in the CT image data. In this case, a training data set that includes two-dimensional CT image data obtained by imaging the target organ as learning image data and includes two-dimensional coordinate values of the point-cloud position representing the contour of the target organ as ground truth data is used. In the present modification, as the pixel value at the position corresponding to the coordinate values of the correct contour point included in the ground truth data of the acquired training data set is located closer to the theoretical CT value indicating the spatial X-ray absorption value of the target organ, the information processing apparatus 10 calculates the goodness of fit to be higher. Further, as the pixel value at the position corresponding to the coordinate values of the correct contour point included in the ground truth data is located farther from the theoretical CT value, the information processing apparatus 10 calculates the goodness of fit to be lower. The information processing apparatus 10 then calculates a loss value based on the calculated goodness of fit and generates an estimator such that the loss value is minimized.

In the present modification, as an example of the method for calculating the goodness of fit, the goodness of fit of the ground truth data can be reduced at a position where the CT value of a part of the contour is higher than the original CT value due to occurrence of a metal artifact in the image. However, the modality to be used, the region, and the disorder are not limited to the above example.

As described above, the information processing apparatus 10 according to the present modification can perform the estimation process by using image data obtained from a modality other than the three-dimensional cardiac ultrasound image data.

### Modification 1-5

Next, Modification 1-5 will be described. The information processing apparatus 10 according to Embodiment 1 multiplies, in step S120, the error value by the goodness of fit of each contour point calculated in step S122 each time the processing from step S123 to step S126 is repeated. On the other hand, the information processing apparatus 10 according to the present modification multiplies the error value between the estimated data and the ground truth data by the goodness of fit in some of the repeated processing from step S123 to step S126. For example, the information processing apparatus 10 omits the processing of multiplying the error value by the goodness of fit until the number of elapsed epochs from the start of the learning has reaches half the maximum number of epochs. Next, the information processing apparatus 10 performs the processing of multiplying the error value by the goodness of fit after the number of elapsed epochs from the start of the learning has reached half the maximum number of epochs. In this way, all the training data set is used in some of the epochs, it is possible to reduce estimation biased to a certain region having a higher goodness of fit.

In Embodiment 1, the method for generating the estimator based on deep learning such as a CNN has been used as an example. However, the method for generating the estimator is not limited thereto. In the present modification, for example, an estimator other than the CNN based on deep learning, such as a vision transformer, can also be used. In this case, too, the information processing apparatus 10 can use the calculated goodness of fit for training the estimator by using the same method as that described in Embodiment 1.

Further, in the present modification, a classifier based on a known method other than deep learning, including ensemble learning such as Random Forest or Adaboost, may be used instead of the estimator described above. In this case, too, the goodness of fit according to Embodiment 1 can be applied to the training of the classifier. In this case, the classifier determines whether the input coordinate values of the point-cloud position representing the contour are “appropriate as the coordinate values of the point-cloud position representing the contour (that is, positive or negative)”. The information processing apparatus 10 then feeds a large number of parameters to the classifier in the estimation process according to Embodiment 1 described above, and adopts a candidate determined to be “appropriate as the coordinate values of the point-cloud position representing the contour”.

In the training of the classifier by the information processing apparatus 10, a function for dividing the learning data into positive and negative is calculated. When the cost for this function is calculated, the calculation is performed such that a larger weight is applied to the coordinate values having higher goodness of fit and a smaller weight is applied to the coordinate values having lower goodness of fit. In this way, even when the information processing apparatus 10 uses the classifier based on a method other than deep learning for the contour estimation, the information processing apparatus 10 can use the above-described goodness of fit for the training of the classifier.

In addition, in the information processing apparatus 10 according to Embodiment 1, the ground truth data is configured by using coordinate values created by annotation performed by a doctor or a technician as the coordinate values of the correct contour point cloud. In the present modification, for example, when there is image data for which there is no corresponding ground truth data based on the coordinate values created by the annotation, data configured by using coordinate values estimated by another estimator may be included in the training data set as the ground truth data.

For example, in semi-supervised learning, the information processing apparatus 10 performs normal training by using the ground truth data created by the annotation, and by using the estimator created as a result of the training, the information processing apparatus 10 performs estimation using the image data having no corresponding ground truth data as the input. Next, by using the estimated data as a pseudo ground truth data, the information processing apparatus 10 adds the image data and the pseudo ground truth data to the training data set as a training data pair. The information processing apparatus 10 then performs the same estimation process as in Embodiment 1 by using the training data set including the training data pair based on the pseudo ground truth data.

Since the training data pair based on the pseudo ground truth data uses the coordinate values estimated by the estimator, the reliability of this type of training data pair is considered to be lower than that of the training data pair based on the ground truth data created by the annotation. In view of this, in the present modification, the information processing apparatus 10 may calculate the goodness of fit of the training data pair based on the pseudo ground truth data to be lower than the goodness of fit of the training data pair based on the ground truth data. For example, the information processing apparatus 10 calculates goodness of fit in the same manner as the processing in step S122 in Embodiment 1, then reduces the level of the calculated goodness of fit at a certain rate, and uses the obtained goodness of fit as the goodness of fit of the pseudo ground truth data. In this way, even when there are only a small number of ground truth data annotated by a doctor or a technician, the information processing apparatus 10 can form a training data set by combining with the ground truth data obtained without annotation, and the estimation process similar to that in Embodiment 1 can be realized.

### Modification 1-6

Next, Modification 1-6 will be described. The information processing apparatus 10 according to Embodiment 1 estimates the coordinate values of the point-cloud position representing the endocardial contour of the right ventricular region by performing the processing from step S110 to step S130 and displays the estimated data in such a manner that the estimated data is superimposed on the image of the input image data in step S140. On the other hand, the information processing apparatus 10 according to the present modification does not display all the coordinate values obtained as the estimated data by the same method in step S140. Instead, the information processing apparatus 10 according to the present modification calculates the goodness of fit for each set of coordinate values and displays each coordinate position by a different method in accordance with the calculated goodness of fit.

The information processing apparatus 10 calculates the goodness of fit of the estimated data for each contour point of the input image data based on the input image data by using a method similar to the method for calculating the goodness of fit of the ground truth data for each contour point of the learning image data based on the learning image data in step S122 in Embodiment 1. That is, in step S122, the information processing apparatus 10 replaces the ground truth data with the estimated data, replaces the learning image data with the input image data, and calculates and acquires the goodness of fit of each estimated data (set of estimated coordinate values).

Next, the information processing apparatus 10 displays the point corresponding to the coordinate values by a different method in accordance with the goodness of fit of each set of coordinate values indicated by each estimated data. As an example, the information processing apparatus 10 displays the point corresponding to the coordinate values indicated by estimated data having high goodness of fit as a clear point on the display unit 36 and displays the point corresponding to the coordinate values indicated by estimated data having low goodness of fit as an unclear point on the display unit 36 by using Gaussian distribution or the like. As another display method, the information processing apparatus 10 may change the shade or size of the point corresponding to the coordinate values indicated by the estimated data in accordance with its goodness of fit. Since the display differs in accordance with the goodness of fit of each point corresponding to the coordinate values indicated by the estimated data, the user can determine how reliable the estimated data is and can use this determination for an operation such as correction of the estimated data.

### Embodiment 2

Next, an information processing apparatus according to Embodiment 2 will be described. In the following description, the same reference numerals are given to the same components as those of Embodiment 1, and the detailed description thereof will be omitted.

As in Embodiment 1, an information processing apparatus 10 according to Embodiment 2 has a function of estimating the coordinate values of the point-cloud position representing the contour of an object from input image data, which is an image in which the object is rendered. In Embodiment 1, the information processing apparatus 10 calculates and acquires goodness of fit based on learning image data and ground truth data included in a training data set. On the other hand, the information processing apparatus 10 according to the present embodiment acquires the goodness of fit from information other than the training data set. In the following description, as an example of the present embodiment, it is assumed that the information processing apparatus 10 acquires the goodness of fit from information other than the training data set and estimates coordinate values of a point-cloud position representing the endocardial contour of a right ventricular region by using three-dimensional cardiac ultrasound image data as input.

The configuration of the information processing apparatus 10 according to the present embodiment is the same as that of Embodiment 1 described with reference to FIG. 1. However, as will be described below, processing performed by a goodness-of-fit acquisition unit 46 of the information processing apparatus 10 according to the present embodiment is different from that in Embodiment 1.

In the present embodiment, it is assumed that a piece of ground truth data and the goodness of fit of each piece of the ground truth data are associated with each other and stored in a database 22 or a storage unit 34. The goodness-of-fit acquisition unit 46 acquires the goodness of fit of the ground truth data, which has been acquired from information other than the learning image date and the ground truth data included in the training data set, from the database 22 or the storage unit 34.

Next, a process performed by the information processing apparatus 10 according to the present embodiment will be described. A flowchart and a sub-flowchart of the process performed by the information processing apparatus 10 according to the present embodiment are the same as those in Embodiment 1. However, the processing in step S122 performed by the information processing apparatus 10 according to the present embodiment differs from that in Embodiment 1.
(Step S122: Acquire Goodness of Fit of Ground Truth Data) In step S122, the goodness-of-fit acquisition unit 46 acquires the goodness of fit for the learning image data and the ground truth data acquired in step S121. This goodness of fit is calculated from information other than the training data set.

In the present embodiment, as an example, a case where the goodness of fit calculated by using patient's medical information is acquired will be described. Specifically, the information processing apparatus 10 acquires the goodness of fit calculated by using an ejection fraction (EF) value indicating a contraction function of the ventricle as the patient's medical information. For example, in the case of training data relating to a patient with a low EF value, the heart of this patient has a lower blood volume and a smaller tricuspid opening, compared to the heart with a normal EF value. Therefore, in the image data of this patient, the contour points near the tricuspid are rendered at a position different from the position of the tricuspid valve of the normal heart. As a result, the reliability of the ground truth data may be reduced. Thus, the goodness of fit of the ground truth data is calculated for each contour point near the tricuspid valve based on the difference in the EF value from the normal value, and the ground truth data and the corresponding goodness of fit are associated with each other and stored in the database 22 or the storage unit 34. The information processing apparatus 10 acquires the calculated goodness of fit from the database 22 or the storage unit 34. In this way, when the training data for the patient with a condition is processed, the information processing apparatus 10 can reduce the impact of the fact that the reliability of the ground truth data is likely to be reduced because a misalignment of the normal training data and the ground truth data occurs due to the presence of the condition.

Besides the above example, the information processing apparatus 10 may acquire goodness of fit calculated by using information about a cardiac phase. Specifically, when the cardiac phase is an end-diastole phase (ED phase), the vicinity of the tricuspid annulus has a large movement, and the position of the tricuspid annulus is likely to be dispersed depending on the training data. Therefore, the goodness of fit is calculated such that the goodness of fit of the ground truth data becomes lower. On the other hand, when the cardiac phase is an end-systolic phase (ES phase), the vicinity of the tricuspid annulus has a small movement, and the position of the tricuspid annulus is less likely to be dispersed depending of the training data. Therefore, the goodness of fit is calculated such that the goodness of fit of the ground truth data becomes higher. Next, the ground truth data and the corresponding goodness of fit are associated with each other and stored in the database 22 or the storage unit 34. The information processing apparatus 10 acquires the calculated goodness of fit from the database 22 or the storage unit 34. In this way, the information processing apparatus 10 can reduce the impact of the fact that the reliability is expected to be low because a specific position in the image data has a large movement on the learning with the ground truth data. As a result, the information processing apparatus 10 can prevent a decrease in the estimation accuracy.

As described above, the information processing apparatus 10 according to the present embodiment can perform training in consideration of the reliability of the individual ground truth data included in the training data set so that a decrease in accuracy of the contour estimation CNN can be prevented.

### Embodiment 3

Next, an information processing apparatus according to Embodiment 3 will be described. In the following description, the same reference numerals are given to the same components as those of the embodiments described above, and the detailed description thereof will be omitted.

An information processing apparatus 10 according to Embodiment 3 has a function of performing segmentation of the region of an object based on input image data, which is an image in which the object is rendered. In the following description, as an example of the present embodiment, a right ventricular region, which is an object, is estimated by using two-dimensional cardiac ultrasound image data captured in a cardiac ultrasound examination as input image data, and the estimated region is segmented.

In the learning process of the present embodiment, the information processing apparatus 10 generates an estimator for segmenting the right ventricular region by using a training data set including a plurality of training data pairs, each of which is a set (pair) of two-dimensional cardiac ultrasound image data and ground truth data of the right ventricular region. In the estimation process of the present embodiment, unknown two-dimensional cardiac ultrasound image data is fed as input image data, and the information processing apparatus 10 estimates the right ventricular region, which is an estimation target, by using the generated estimator.

Hereinafter, the processing performed by the information processing apparatus 10 according to the present embodiment will be described in detail. As in Embodiments 1 and 2, the information processing apparatus 10 acquires, as input image data, two-dimensional cardiac ultrasound image data captured by a user such as a doctor or a technician using an ultrasound probe. Next, the information processing apparatus 10 acquires the estimator generated as described above and performs the estimation process on the input image data.

The information processing apparatus 10 acquires the estimator as follows. First, the information processing apparatus 10 acquires a training data set including a plurality of training data pairs each of which includes two-dimensional cardiac ultrasound image data and image data (ground truth data) representing a correct output (correct region) of the right ventricular region in the two-dimensional cardiac ultrasound image data. Next, based on pixel values at the position corresponding to the correct region in the two-dimensional cardiac ultrasound image data, the information processing apparatus 10 calculates, for the training data set, goodness of fit that indicates how reliable the position is as the correct region on the image. Next, the information processing apparatus 10 calculates a loss value relating to the ground truth data based on the goodness of fit of the position corresponding to the correct region. The information processing apparatus 10 then adjusts the learning parameters of the CNN such that the calculated loss value is minimized. Here, the two-dimensional cardiac ultrasound image data and the ground truth data of the right ventricular region are examples of learning image data and ground truth data, respectively. The CNN according to the present embodiment is the estimator that performs segmentation of the region of the object from image data such as U-Net.

The configuration of the information processing apparatus 10 according to the present embodiment is the same as that of Embodiment 1 described with reference to FIG. 1. However, as will be described below, the processing performed by a goodness-of-fit acquisition unit 46 and a learning unit 47 of the information processing apparatus 10 according to the present embodiment differs from that in Embodiment 1.

The goodness-of-fit acquisition unit 46 calculates the goodness of fit of the ground truth data by using each training data pair included in the training data set based on the pixel value of the learning image data at the position of each pixel included in the correct region of the ground truth data. Specifically, the goodness-of-fit acquisition unit 46 calculates the goodness of fit based on the pixel values of the two-dimensional cardiac ultrasound image data at the position in the right ventricular region indicated by the ground truth data.

The learning unit 47 uses the estimator determined by the parameters of the current CNN to estimate the right ventricular region (estimated data, estimated region image data) in the learning image data by using each training data pair included in the training data set. Next, the learning unit 47 calculates an error value between the estimated data and the ground truth data by using a preset error evaluation function. The learning unit 47 then calculates a loss value by multiplying the calculated error value by the goodness of fit acquired by the goodness-of-fit acquisition unit 46 as a weight. Next, the learning unit 47 performs the same processing as that performed by the learning unit 47 in Embodiment 1 and generates an estimator by optimizing the parameters of the CNN such that the calculated loss value is minimized.

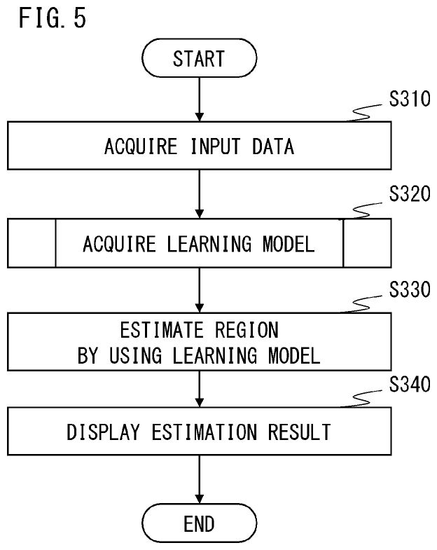

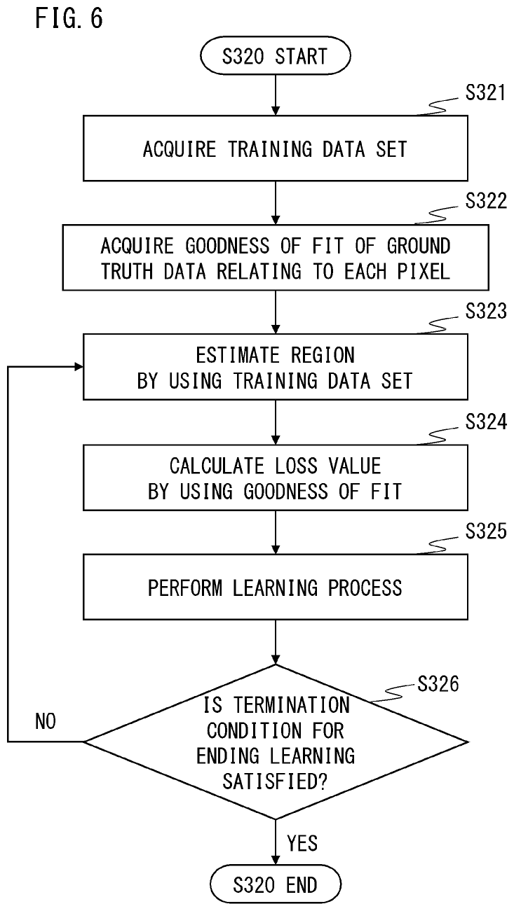

Hereinafter, an example of a process performed by the information processing apparatus 10 according to the present embodiment will be described in detail with reference to a flowchart in FIG. 5 and a sub-flowchart in FIG. 6. In FIG. 5, processing in step S310 is the same as the processing in step S110 in Embodiment 1. Processing in step S320 will be described with reference to FIG. 6. In FIG. 6, processing in steps S321, S325, and S326 is the same as the processing in steps S121, S125, and S126 in Embodiment 1, respectively.
(Step S322: Acquire Goodness of Fit of Ground Truth Data Relating to Each Pixel) In step S322, for each training data pair included in the training data set acquired in step S321, the goodness-of-fit acquisition unit 46 calculates and obtains the goodness of fit of the ground truth data relating to each pixel based on the pixel value of each pixel of the learning image data. Specifically, the goodness-of-fit acquisition unit 46 calculates and obtains the goodness of fit for each pixel of the two-dimensional cardiac ultrasound image data included in the training data pair based on its corresponding pixel value. The right ventricular region is a chamber region that is separated from other adjacent regions by a wall. Typically, in an ultrasound image, the wall is rendered with a high pixel value, and the chamber is rendered with a low pixel value. That is, a region having a low pixel value is extracted as a chamber region by the process for estimating the right ventricular region according to the present embodiment. Therefore, the goodness-of-fit acquisition unit 46 calculates the goodness of fit for each pixel in the right ventricular region in the ground truth data such that the goodness of fit becomes higher for the pixel having a low pixel value in the two-dimensional cardiac ultrasound image data. Further, the goodness-of-fit acquisition unit 46 calculates the goodness of fit for each pixel in the right ventricular region in the ground truth data such that the goodness of fit becomes lower for the pixel having a higher pixel value in the two-dimensional cardiac ultrasound image data.

Instead of using the above-described method for calculating the goodness of fit, the goodness-of-fit acquisition unit 46 may calculate the goodness of fit such that the goodness of fit becomes lower for pixels in a region near the boundary between the wall and the chamber, that is, the peripheral region of the contour of the right ventricular region, in which an error is likely to occur when the ground truth data is generated. In addition, the goodness-of-fit acquisition unit 46 may calculate the goodness of fit such that the goodness of fit becomes higher for the pixels in the region inside the chamber.

The goodness-of-fit acquisition unit 46 may calculate the goodness of fit such that the goodness of fit becomes lower for a pixel having a large noise in the learning image data and the goodness of fit becomes higher for a pixel having a small noise. The magnitude of noise in the learning image data can be obtained by using a known method. In addition, for example, the goodness-of-fit acquisition unit 46 may acquire moving image data captured in a cardiac ultrasound examination as learning image data and calculate the goodness of fit such that the goodness of fit becomes lower for a pixel in the region where a large movement is observed in the moving image data compared to the previous and subsequent frames. An example of the region where a large movement is observed compared to the previous and subsequent frames includes a region such as a valve annulus. It can be said that an error of the ground truth data is likely to occur in such a region.
(Step S323: Estimate Region by Using Training Data Set) In step S323, the learning unit 47 performs estimation on the learning image data acquired in step S321 by using an estimator (learning model) generated by using parameters of the current (presently learning) CNN. The learning unit 47 then acquires image data (estimated data, estimated region) of the right ventricular region as an estimation result.
(Step S324: Calculate Loss Value by Using Goodness of Fit) In step S324, the learning unit 47 calculates an error value based on the difference between the correct value and the estimated value of each pixel from the estimated region calculated in step S323 and the ground truth data (correct region) in the training data set acquired in step S321. Next, the learning unit 47 multiplies the calculated error value by the goodness of fit of the corresponding pixel calculated in step S322. Further, the learning unit 47 calculates a loss value by adding up all the multiplication results obtained for the respective pixels, for example.

In the present embodiment, the loss value is calculated by the following Expression (1) based on the estimated region and the correct region of the right ventricular region. In Expression (1), i and j are indexes representing the position of a pixel in the learning image data and represent the position of a pixel at the i-th row and the j-th column of the learning image data. Further, w represents the goodness of fit of the pixel acquired in step S322, yₜᵣᵤₑ is the correct pixel value of each pixel, and y_{pred} is the estimated pixel value of each pixel. Here, the correct value is 1 when the pixel is included in the correct region and 0 when the pixel is not included in the correct region.

$$[ Math 1 ]$$

$$Loss = 1 - \frac{2 * {\sum }_{ij} ( {y}_{{true}_{ij}} * {y}_{{pred}_{ij}} * {w}_{ij} )}{{\sum }_{ij} ( {y}_{{true}_{ij}} + {y}_{{pred}_{ij}} )} \qquad ( 1 )$$

(Step S330: Estimate Region by Using Learning Model) In step S330, the estimation unit 44 acquires the estimator (learning model) trained in step S320 from the storage unit 34. The estimation unit 44 feeds the two-dimensional cardiac ultrasound image data acquired in step S310 to the estimator and estimates the right ventricular region rendered in the two-dimensional cardiac ultrasound image data.
(Step S340: Display Estimation Result) In step S340, the display processing unit 48 outputs the input image data and the estimated region based on the result of the estimation in step S330. The two-dimensional cardiac ultrasound image data, which is the input image data, is displayed on the display unit 36, and the position of the pixels corresponding to the right ventricular region estimated in step S330 is superimposed on the two dimensional cardiac ultrasound image data.

Thus, in the generation of the estimator for estimating the region of an object in the input image data, the information processing apparatus 10 according to the present embodiment can perform training based on the goodness of fit of the training data set. By estimating the region of the object in the input image data by using the estimator generated in this way, the information processing apparatus 10 can estimate the region of the object without decreasing the estimation accuracy even when the training data set includes training data with low reliability.

### Other Embodiments

The present invention can also be realized by supplying a program for realizing one or more functions of the above-described embodiments to a system or an apparatus via a network or a storage medium and causing one or more processors of a computer in the system or the apparatus to read out and execute the program. The present invention can also be realized by a circuit (for example, ASIC) that realizes one or more functions.

The technique according to the present disclosure can be implemented as, for example, a system, an apparatus, a method, a program, or a recording medium (storage medium). Specifically, the technique according to the present disclosure may be applied to a system including a plurality of devices (for example, a host computer, an interface device, an image capturing apparatus, and a web application) or may be applied to an apparatus constituted by a single device.

Needless to say, the object of the technique according to the present disclosure is achieved by the following configurations. That is, a recording medium (or a storage medium) storing a program code (computer program) of software for realizing the functions of the above-described embodiments is supplied to a system or an apparatus. Obviously, the storage medium is a computer-readable storage medium. Next, a computer (or a CPU or MPU) of the system or the apparatus reads out and executes the program code stored in the recording medium. In this case, the recording medium in which the program code read out from the recording medium is recorded constitutes the technique of the present disclosure.

According to the technique of the present disclosure, the accuracy of estimation on an object in an image can be improved.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-064794, filed on Apr. 12, 2023, which is hereby incorporated by reference herein in its entirety.

What is claimed is:

1. An information processing apparatus for generating a learning model that performs, by using input image data obtained by imaging an object, estimation relating to the object rendered in the image data, the information processing apparatus comprising at least one processor capable of causing the information processing apparatus to function as:
a training data acquisition unit configured to acquire, as training data used for generating the learning model, learning image data obtained by imaging the object and ground truth data indicating information about the object in the learning image data;
a goodness-of-fit acquisition unit configured to acquire goodness of fit relating to the ground truth data; and
a learning unit configured to perform training on the learning model based on the training data and the goodness of fit.

2. The information processing apparatus according to claim 1, wherein
the learning model is a learning model for estimating spatial information about the object in the image data, and
the training data acquisition unit acquires information about a region of the object as ground truth data in the training data.

3. The information processing apparatus according to claim 1, wherein
the learning model is a learning model for estimating a position of a feature point of the object in the image data, and
the training data acquisition unit acquires information about the position of the feature point of the object as ground truth data in the training data.

4. The information processing apparatus according to claim 1, wherein
the learning model is a learning model for estimating a contour of the object in the image data, and
the training data acquisition unit acquires information about the contour of the object as ground truth data in the training data.

5. The information processing apparatus according to claim 1, wherein
the goodness-of-fit acquisition unit calculates the goodness of fit, based on pixel values of a periphery of a position of the object in the learning image data, the position of the object being indicated by the ground truth data in the training data.

6. The information processing apparatus according to claim 5, wherein
The goodness-of-fit acquisition unit calculates the goodness of fit, based on a luminance gradient indicated by the pixel values.

7. The information processing apparatus according to claim 3, wherein
the goodness-of-fit acquisition unit calculates the goodness of fit of an individual feature point of the ground truth data in the training data, based on a positional relationship between the individual feature point and a feature point other than the individual feature point.

8. The information processing apparatus according to claim 7, wherein
the positional relationship is a curvature of a contour line of the object based on the feature points.

9. The information processing apparatus according to claim 1, wherein
The goodness-of-fit acquisition unit calculates the goodness of fit, based on information other than the training data relating to the object.

10. The information processing apparatus according to claim 1, wherein
the learning unit performs training on the learning model by applying the goodness of fit to a difference between an estimated value relating to the object, which is estimated by the learning model, and a correct value relating to the object, which is indicated by the ground truth data.

11. The information processing apparatus according to claim 10, wherein
the estimated value and the correct value are a pixel value of a pixel corresponding to the object.

12. An information processing apparatus, comprising at least one processor capable of causing the information processing apparatus to function as:
a data acquisition unit configured to acquire input image data obtained by imaging an object;
a learning model acquisition unit configured to acquire a learning model generated by learning based on learning image data obtained by imaging the object, ground truth data indicating information about the object in the learning image data, and goodness of fit relating to the ground truth data; and
an estimation unit configured to perform an estimation process relating to the object rendered in the input image data by using the input image data and the learning model.

13. The information processing apparatus according to claim 12, wherein the at least one processor causes the information processing apparatus to further function as a display processing unit configured to display an estimation result of the estimation unit.

14. The information processing apparatus according to claim 13, wherein the at least one processor causes the information processing apparatus to further function as a goodness-of-fit acquisition unit configured to acquire goodness of fit relating to the input image data, and
the display processing unit displays the goodness of fit relating to the input image data.

15. The information processing apparatus according to claim 12, wherein
the learning model is generated by learning based on a result obtained by applying the goodness of fit to a difference between an estimation result of the estimation unit and the ground truth data.

16. An information processing method for generating a learning model that performs, by using input image data obtained by imaging an object, estimation relating to the object rendered in the image data, the information processing method comprising:
a training data acquisition step of acquiring, as training data used for generating the learning model, learning image data obtained by imaging the object and ground truth data indicating information about the object in the learning image data;
a goodness-of-fit acquisition step of acquiring goodness of fit relating to the ground truth data; and
a learning step of performing training on the learning model, based on the training data and the goodness of fit.

17. An information processing method, comprising:
a data acquisition step of acquiring input image data obtained by imaging an object;
a learning model acquisition step that acquires a learning model generated by learning, based on learning image data obtained by imaging the object, ground truth data indicating information about the object in the learning image data, and goodness of fit relating to the ground truth data; and
an estimation step of performing an estimation process relating to the object rendered in the input image data by using the input image data and the learning model.

18. A non-transitory computer-readable storage medium with an executable program stored thereon, that when executed, instructs a processor to perform the method of claim 16.

19. A non-transitory computer-readable storage medium with an executable program stored thereon, that when executed, instructs a processor to perform the method of claim 17.
